(19) United States
(12) Patent Application Publication
(10) Pub. No.: US 2013/0127092 A1
(43) Pub. Date: May 23, 2013

(54) MOULDED MULTILAYER PLASTICS COMPONENT WITH CONTINUOUSLY REINFORCED FIBRE PLIES AND PROCESS FOR PRODUCING THIS COMPONENT

(71) Applicants: Willy Dauner, Leonberg (DE); Frank Hoecker, Dornstadt (DE)

(72) Inventors: Willy Dauner, Leonberg (DE); Frank Hoecker, Dornstadt (DE)

(73) Assignee: DAIMLER AG, Stuttgart (DE)

(21) Appl. No.: 13/811,717

(22) PCT Filed: Jul. 26, 2011
(86) PCT No.: PCT/EP2011/003730

§ 371 Date: Jan. 23, 2013

(30) Foreign Application Priority Data
Aug. 6, 2010 (DE) 10 2010 033 627.0

(51) Int. Cl. B29C 44/12

(52) U.S. Cl. CPC B29C 44/12
USPC 264/415; 264/46.5

(57) ABSTRACT

A molded multilayer plastics component (1) with continuously reinforced fiber plies (2, 2′), which has a sandwich structure made of an internal structure (3) made of a foam material, embedded between at least two outer plies of fiber composite plastic. Around the periphery of the embedded internal structure (3) the component (1) has a coherent edge made of the fiber composite plastic, formed through peripheral overdimensioning (2″) of at least one of the fiber plies (2, 2′) with respect to the internal structure (3). Two alternative production processes are also disclosed for producing the multilayer plastics component (1).

The invention relates to a molded multilayer plastics component with continuously reinforced fiber plies, which has a sandwich structure with a foamed internal structure. Furthermore the invention relates to two alternative production processes for such multilayer plastics components.

It is generally known to produce lightweight components, which must hold out when subjected to large mechanical loads, using duromer composite material systems. Furthermore the arrangement of sandwich components is known, where layers of low density and layers of high rigidity are joined together in order to obtain such a highly stress-resistant lightweight component with good mechanical stability values.

Thus DE 103 47 598 A1 describes a component, especially an outer skin component for a vehicle, which with a plastic outer shell having high surface quality is produced in a so-called sheet molding compound-, or bulk molding compound- or RTM process. It is also disposes of an internal reinforcing structure, lying flat on the outer shell, which is delimited by two plastic films spaced apart from one another. A honeycomb structure or a foam-like material is provided between these plastic films. This component is produced in a tool, which has a matrix and two exchangeable punches, wherein the outer shell is initially produced in a first step using a first punch. Thereupon the reinforcing structure is placed on the outer shell remaining in the tool and the punch is exchanged, so that the contour of the reinforcing structure can be shaped in second step and the outer shell can be compressed with the reinforcing structure.

Furthermore DE 10 2008 052 967 A1 discloses a multilayer flat component for a vehicle which has a plastic core arranged between fibers, wherein the fiber mats are surrounded by covering plastic films and the peripheral edge of the layer construction is compressed at least in sections, in order to make the layer construction as water-tight as possible. As a result of the compressing a peripheral edge with lesser thickness than in the remaining layer construction is created, whereby all layers of the flat component, including the core, are compressed together.

On the basis of this prior art it is desirable to provide an improved multilayer plastics component with continuously reinforced fiber plies, which apart from good mechanical characteristics can also be produced as a molded component with improved material properties. This object is achieved by a molded multilayer plastics component with the features of claim 1.

A further object of the invention is to provide processes for producing such a component. This object is achieved by the alternative processes with the features of claims 4 and 10.

Refinements of the component and the processes are disclosed in the dependent claims.

An inventive molded plastic multi-layer component with continuously reinforced fiber plies, which has a sandwich structure made of an internal structure made of a foam material, embedded between at least two outer plies of fiber composite plastic, has a coherent edge around the periphery of the embedded internal structure. This consists of fiber composite plastic and is formed through peripheral overdimensioning of at least one of the fiber plies, between which the internal structure is embedded with respect to the internal structure. The fiber plie sections extending over the internal structure are used to form the peripheral edge.

In this case long or continuous fibers are used for the fiber plies of the outer plies of fiber composite plastic. Among others glass fibers, carbon fibers and/or aramide fibers, which are present in the composite with a plastic matrix material, come into consideration. Here the fiber plies may include rovings, fabrics, knitted fabrics, mats or tissues. The plastic matrix material is preferably formed by a hardenable resin, which forms a duromer matrix, or by in-situ polymerizing thermoplastic matrix material. The long or continuous fibers can be used especially in the form of fiber arrangements such as rovings, fabrics, knitted fabrics, mats, tissues or the like.

The foam material of the internal structure consists of a thermoplastic or duroplastic component, which is made up with or without fiber content.

Advantageously such a component can be produced in a so-called one step process, wherein only a single press molding tool, which has a punch and a matrix, is required in order to execute the production process. For this purpose initially a first fiber plie is laid in the press molding tool, over which is placed a separator and after the separator a second fiber plie is laid, wherein one or both of the fiber plies are dimensioned, so that in respect to the separator they exhibit a peripheral overdimension, from which the later component edge is formed and which peripherally covers an edge of the separator.

After the plies have been laid, the tool is closed and the plastic matrix material is injected into the fiber plies in order to form the outer plies of fiber composite plastic. Still before they are completely hardened or consolidated, a foamable plastic material is injected into a cavity between the curing outer plies of fiber composite plastic and initiates a foaming process of this plastic material, whereby the expanding foamable plastic material exerts pressure on the curing and consolidating outer plies of fiber composite plastic and thus a firm bond is obtained.

The cavity, into which the foamable plastic material is injected, is formed by the separator, which will therefore have a balloon- or pocket shape. With such a process a high cost benefit can be achieved in the production of the component, since only one tool is necessary and the component is produced during a closing operation of the tool. In addition tooling costs are minimized, since exchange of the punch is also omitted and short cycle times can be achieved.

The component produced in this way also has improved material properties, since the sandwich, which surrounds the composite in the outer plies of fiber composite plastic as well as also towards the foam core lying therebetween, is formed during a single production process. Thus multilayer plastics components with continuously reinforced fiber plies and very good mechanical characteristics, which are employed for use in automobile manufacture under consideration of the parameters concerning lightweight construction can be produced at substantially reduced cost also in large quantities.

Conventional sandwich products with foam core of the prior art have up to now been produced in a two-step process, which comprises a prefabricated sandwich core in combination with outer plies. So far this has led to high costs as well as long production times.

The closed cavity, necessary for injecting the foamable material between the curing outer plies of fiber composite plastic, is formed by the separator, which can be implemented in various ways. One embodiment relates to the fact that the separator is implemented in conformity with the internal structure and delimits the cavity.

In this case it may concern a balloon-like film structure, which is expanded by injecting the foamable plastic material and as a result of the foaming process, until the foam material forms the internal structure.

Alternatively the separator can also be implemented by way of a frame or container, which separates the fiber plies from one another, and into which the foamable plastic material can be injected. With the balloon solution the punch may have to have a certain degree of flexibility in order to permit the component to expand in consequence of the injection and foaming of the foamable plastic material.

Alternatively only one or two separator film layers can also be arranged between the fiber plies, which prevent the two bonding together as the tool closes while the matrix material is being injected, and which allow the press mold to be spaced apart before the fiber composite plastic outer plies are completely hardened or consolidated, until a final desired thickness of the multilayer plastics component to be produced is achieved and in consequence of the separator films the closed cavity is formed between the first and second fiber plie.

The foamable material in one embodiment can also be constituted by the plastic matrix material itself, which as it is injected into the fiber plie at least partly fills the cavity and is foamed there by introducing a propellant, for instance a propellant gas. Also if another foamable agent is used foaming can be caused by injecting a propellant such as a propellant gas. Alternatively foamable plastic materials may be used, the foaming of which can be initiated for example by heat, which is generated there or inducted, or other transmission of energy, for instance using microwaves or ultrasound or light.

In one embodiment the separator can be constituted by a film material, which dissolves in the matrix material during the foaming process. Finally a process for producing a molded multilayer plastics component relates to the fact that instead of the separator, which forms the cavity for injecting the foamable material, a prefabricated internal structure made of prefoamed foam material, that is placed onto the first fiber plie, which is laid in the press molding tool and covered with the second fiber plie, is used. In this case at least one of the two fiber plies has a peripheral overdimension with respect to the internal structure, so that an edge of the internal structure is peripherally covered by at least one fiber plie. Then the tool is closed and a plastic matrix material is injected into the fiber plies, whereby pressure is exerted between the curing outer plies of fiber composite plastic and the internal structure made of foam material, so that the component with the improved material properties is created.

These also materialize due to the fact that with the proposed process the fiber composite plies cure under exertion of internal pressure, which contributes to the shaping. Furthermore the formation of a crushed edge is avoided: As a result in the known process of the fiber plies lying above and below the foam layer joining together, a crushed edge generally forms. If the crushed edge is avoided and instead a butt edge is formed, as proposed in the inventive process, the work-piece can be employed more flexibly.

These and other advantages are demonstrated by the following description with reference to the accompanying figures.

Reference to the figures in the description serves to support the description and easier comprehension of the subject matter. Items or parts of items, which are essentially identical or similar, may be shown with the same reference symbols. The figures are a schematic illustration of only one embodiment of the invention, wherein:

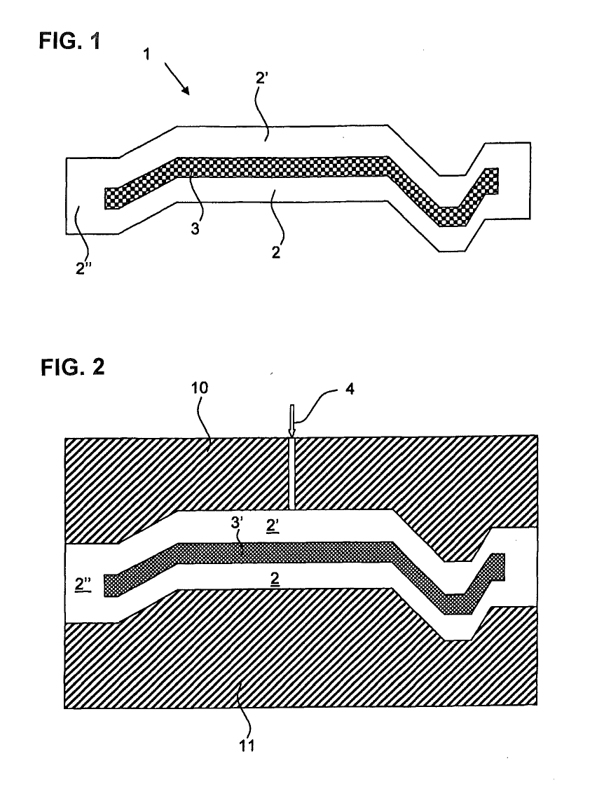

FIG. 1 is a schematic cross-sectional view of a molded plastic multi-layer component with peripheral edge made of fiber composite plastic,

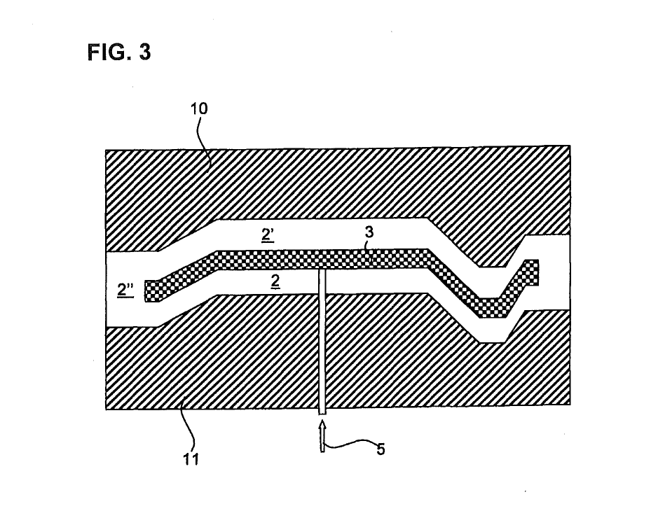

FIG. 2 is a schematic cross-sectional view of a first production stage for the component in the single tool,

FIG. 3 is a schematic cross-sectional view of a second production stage for the component in the single tool.

The inventive component 1, illustrated as an example in FIG. 1 with two outer plies of fiber composite plastic 2, 2′, which sandwich a foamed internal structure 3, has a coherent edge 2″, which peripherally surrounds the internal structure 3. It consists of the same fiber composite plastic as the outer plies 2, 2′.

The increased mechanical characteristics of the component can be obtained by the inventive production process, in which the primary shaping of the fiber plies together with the injection of a matrix plastic for instance by an RTM (resin transfer molding) process is effected in a tool while the foamed internal structure is being constituted. The complete sandwich package made of continuously reinforced outer plies 2, 2′ and foam core 3 is advantageously produced in a one step process, whereby the outer plies made of reinforced continuous fibers are produced in the closed tool in conjunction with a duroplastic matrix.

While these cure or consolidate, a duroplastic or thermoplastic foamable mass, which is foamed or foams as the process proceeds, is injected between these two plies during the course of the production process.

Fiber plies made of long or continuous fibers, which are present for example in the form of fiber arrangements including rovings, fabrics, knitted fabrics, mats or tissues, are used as fiber composite outer plies. Initially such fiber arrangements are laid into the press molding tool or onto the matrix 11, in order to form the first fiber plie 2. Onto these is placed either a separator 3′, which for example can also be a preform made of plastic material or spacer tissue, or a prefabricated insert of polymer foam, which forms the foamed internal structure 3, in each case depending on the version of the process.

The separator 3′ does not necessarily have to reproduce the form of the internal structure 3; it is also conceivable that a separator film or several separator films can be used which permit the formation of the cavity by spacing the punch 10 away from the matrix 11. The separator 3′ may also concern a balloon-like film separator, which is expanded by injecting the foamable agent.

The production process proceeds in such a way that the second fiber plie 2′ is laid over the separator 3′ or onto the prefabricated internal structure 3, wherein the fiber plies 2, 2′ may concern dry fibers or a preform, but under certain circumstances the fiber plies 2, 2′ can also be pre-impregnated. The fiber plies 2, 2′ are constituted in such a way that with respect to the internal structure, respectively the separator 3′, they have an overdimension which is sized so that a peripheral, tighter edge 2″ is provided for the finished component 1.

As the arrow 4 in FIG. 2 indicates, the matrix material is injected into the fiber plies 2, 2′. The matrix material may concern normal polyester or vinyl-ester resins, suitable resins for implementing a resin infusion method according to the RTM process being well-known. However preliminary stages of thermoplastic materials, so-called in-situ polymerizing thermoplastics can also be used. In the version of the process, where a prefabricated insert is used to form the internal structure made of foam material, production is terminated at this point, the resin being allowed to harden/consolidate under corresponding pressure and temperature exposure and the component can be removed.

Where a separator 3′ is used a foamable material is now injected into the cavity between the two layers of 2, 2, formed by the separator 3′. For example molten plastic can be injected, which can be implemented by means of one or several injection nozzles, dependent on the configuration of the component. In this case, as indicated in FIG. 3, the foamable material 5 can be injected through a suitable inlet.

Advantageously as a result of the foaming, pressure is exerted on the curing or consolidating fiber plies 2, 2′ also from the inside, as a result of which the material properties or the mechanical characteristics of the component 1 are improved. In addition the foamed internal structure 3 and the curing outer plies 2, 2′ and also the edge 2″ are firmly bonded together.

The separator or the separator films can be selected from a material, whose melting temperature lies above a melting temperature for executing the primary shaping in order to be able to form the cavity accordingly, but it may also concern a material, which dissolves during the foaming process.

The foam formation of the foamable material can also be initiated in other ways. A propellant such as a propellant gas or chemical agent, which foams the injected plastic component, can be introduced. Foaming however can also be caused by inducting heat or energy in another form, for example using microwaves and ultrasound. Heat can be inducted for example by means of heating wires arranged in the separator.

Advantageously the material for the foamed the internal structure can be constituted by the matrix material itself, which is foamed by introducing a propellant, but other duroplastic or thermoplastic polymer components may also be used, especially a polyurethane foam can be employed.

In the embodiment, where punch and matrix are spaced apart, in order to form the cavity, this spacing can be implemented at the same time as the foam forming process is initiated.

Advantageously the matrix material, whenever the foam forming process is initiated, remains soft so that the forming, expanding foam can press the fiber plies outwards, in such a way that shaping takes place by means of the internal pressure, which is exerted on the still soft material, without any damage being caused through the primary shaping process. As a result of the dimensions of the fiber plies and arrangements in the tool, the peripheral edge is sealed in a water- or air-tight manner and a flush butt is formed, which does not result in a crushed edge.

Furthermore it may be proposed that the sandwich structure has further plies, for example one or several plies made of plastic fleece, which can be merged into the layer structure between fiber mats and separators.

1-10. (canceled)

11. A process for producing a molded multilayer plastics component (1) with continuously reinforced fiber plies (2, 2′), which has a sandwich structure made of an internal structure made of a foam material, embedded between at least two outer plies of fiber composite plastic (3), wherein around the periphery of the embedded internal structure (3), the component (1) has a coherent edge made of the fiber composite plastic formed through peripheral overdimensioning (2″) of at least one of the fiber plies (2, 2′) with respect to the internal structure (3), comprising the steps of:
a) providing a single press molding tool, which has a punch (10) and a matrix (11) to execute the production process, and laying at least one fiber ply (2), placing a separator (3′) thereover, and laying a second fiber ply (2′) onto the separator (3′), wherein at least one of the fiber plies (2, 2′) has a peripheral overdimensioning (2″) with respect to the separator (3′), so that an edge of the separator (3′) is peripherally covered by at least one of the fiber plies (2, 2′),
b) closing of the tool and injecting a hardenable plastic matrix material (4) into the fiber plies (2, 2′),
c) injecting a foamable plastic material (5) into a closed cavity formed by the separator (3′) between the curing outer plies of fiber composite plastic (2, 2′) and initiating a foaming process of the plastic material.

12. The process according to claim 11, wherein the foamable material is constituted by the duroplastic matrix material.

13. The process according to claim 12, wherein the separator (3′) is implemented by at least one separator film layer and wherein the process comprises the step of c₀) moving the punch (10) and the matrix (11) away from each other, until the distance provided therebetween corresponds to a thickness of the multilayer plastics component to be produced, wherein the closed cavity between the first and the second fiber ply is formed by the separator film layer.

14. The process according to claim 11, wherein the separator in the matrix material dissolves during the foaming process.

15. The process according to claim 11, and wherein in step c) initiating of the foaming process comprises:
injecting a propellant, or
inducting heat or light, or conducting microwaves or ultrasonic waves into the foamable plastic material which is present in the cavity.

16. The process according to claim 15, wherein the propellant is a propellant gas.
